(19) United States
(12) Patent Application Publication
(10) Pub. No.: US 2011/0128846 A1
(43) Pub. Date: Jun. 2, 2011

(54) METHOD FOR CONTROLLING ACCESS OF COMMUNICATION MEDIUM ACCORDING TO MAC PROTOCOL OF IEEE 802.11

(75) Inventors: Choong-Seon Hong, Gyeonggi-do (KR); Rahman MD. Mustafizur, Gyeonggi-do (KR); Hamid MD. Abul, Gyeonggi-do (KR); Jin-Ho Kim, Gyeonggi-do (KR)

(73) Assignee: University Industry Cooperation Group of Kyung Hee University, Yongin-si Gyeonggi-do (KR)

(21) Appl. No.: 13/056,296

(22) PCT Filed: Jul. 31, 2008
(86) PCT No.: PCT/KR2008/004461

§ 371 Date: Jan. 27, 2011

(30) Foreign Application Priority Data
Jul. 28, 2008 (KR) 10-2008-0073702

(51) Int. Cl. H04L 12/26

(52) U.S. Cl. 370/230

(57) ABSTRACT

The present invention relates to a method of controlling access to a wireless channel in a wireless communication system, and more particularly, to such a method of controlling wireless channel access, in which it is determined whether or not peripheral communication nodes are ones interrupting main communication between communication nodes being activated, and if it is determined that the peripheral communication nodes are ones which does not interrupt the main communication, they gain access to a wireless channel so as to perform parallel communication with respect to the main communication. The wireless channel access control method according to the present invention determines whether or not peripheral communication nodes actually interrupt main communication, and if it is determined that the peripheral communication nodes are ones which does not interrupt the main communication, they gain access to a wireless channel so as to perform parallel communication with respect to the main communication, thereby efficiently utilizing a limited wireless channel resource.

### TECHNICAL FIELD

The present invention relates to a method of controlling access to a wireless channel in a wireless communication system, and more particularly, to such a method of controlling wireless channel access, in which it is determined whether or not peripheral communication nodes are ones interrupting main communication between communication nodes being activated, and if it is determined that the peripheral communication nodes are ones which does not interrupt the main communication, they gain access to a wireless channel so as to perform parallel communication with respect to the main communication.

### BACKGROUND ART

A wireless communication network comprises a plurality of communication nodes sharing a single wireless channel, and a transmitting communication node among the plurality of communication nodes transmits data to a receiving communication node using the wireless channel.

FIG. 1 is a diagram illustrating one example of a wireless LAN (WLAN) network including eight communication nodes.

Referring to FIG. 1(a), there is shown an ad-hoc (i.e., peer-to peer) type wireless LAN (WLAN) network. The ad-hoc type wireless LAN network adopts a network structure in which eight communication nodes 1 to 8 constituting the wireless LAN (WLAN) network connect to a common wireless channel so as to perform wireless communication therebetween without a separate access device (access point: AP). In such an ad-hoc type WLAN network, since there is no access device (AP) for controlling communication between the transmitting and receiving communication nodes, the respective communication nodes maximally utilize their own intrinsic information to perform communication therebetween over the network, and communicate with a remote communication node via other nodes.

Meanwhile, referring to FIG. 1(b), there is shown an infrastructure type wireless LAN (WLAN) network in which a plurality of communication nodes 1 to 8 gain access to an access device (AP) 10. Also, the access point 10 wiredly connects to the Internet or a wired network 11. The plurality of communication nodes 1 to 8 performs communication therebetween or communicates with the Internet or the wired network 11 through the access device 10. Currently, the infrastructure type WLAN network is widely used in even business environments such as air ports, department stores, amusement parks and so forth as well as dwelling environments such as apartments, private homes and so forth.

Both the ad-hoc type wireless LAN network and the infrastructure type wireless LAN network as mentioned above allow the plurality of communication nodes to share a single wireless channel so as to perform communication therebetween. Thus, in the case where a transmitting communication node and a receiving communication node perform main communication therebetween using the wireless channel, if other communication nodes attempt to gain access to the wireless channel so as to perform the communication, noise signals from the other communication nodes interrupt the main communication between the transmitting communication node and a receiving communication node.

IEEE 802.11 is a set of standards specifying the technologies for the wireless LANs, developed by the IEEE LAN/MAN standard committee. There have been developed several specifications such as 802.11, 802.11a, 802.11b, 802.11g, etc., as the IEEE standards. As can be seen in “Wireless LAN Medium Access Control (MAC) and Physical Layer (PHY) Specifications, 1999 Edition”, the IEEE 802.11 standard defines the medium access control (MAC) protocol and physical layer (PHY. In general, the function of the MAC protocol layer is to allow a plurality of communication nodes to access a single shared wireless channel with minimum interference and maximum performance. Most wireless LAN network employs a Carrier Sense Multiple Access with Collision Avoidance (CSMA/CA) scheme so as to control the wireless channel access. The IEEE 802.11 standard specifies two types of Carrier Sense Multiple Access with Collision Avoidance (CSMA/CA) schemes. Among both of them, one is a distributed coordination function (DCF) protocol and the other is a point coordination function (PCF) protocol.

More specifically, the distributed coordination function (DCF) protocol prevents collision between signals through carrier sense.

All the communication nodes senses whether or not other communication nodes gain access to the shared wireless channel to perform communication therebetween through carrier detection prior to transmission of data. When a communication mode attempting to access the wireless channel to perform communication senses a carrier with a strength of more than a carrier sense threshold (CST), received from another communication node, it restricts the access to the wireless channel in order not to interfere the communication of the other communication node.

Typically, the interference range defined by the carrier sense threshold is larger than the communication range of the communication node. Thus, there exist a lot of peripheral communication nodes which are in the interference range of an activated communication node, but not in the communication range of the activated communication node. Resultantly, the distributed coordination function (DCF) protocol determines all the peripheral communication nodes which are in the interference range of the activated communication node to be interference nodes, and controls such that the peripheral communication nodes do not access a wireless channel during the communication period of the communication node being activated.

FIG. 2 is a flowchart illustrating one example of a method of controlling access to a wireless channel for transmitting and receiving data in accordance with a conventional distributed coordination function (DCF) protocol. In order to transmit and receive data, a transmitting communication node and a receiving communication node perform a handshaking using a transmitting request message RTF (Request to Send) and a transmission confirmation message CTS (Clear to Send) before performing data communication therebetween.

More specifically, referring to FIG. 2, a plurality of communication nodes shares a single wireless channel for transmission and reception of data. In the case where the plurality of communication nodes simultaneously attempt to perform communication, signals received by a receiving communication node Rx may collide. In order to avoid collision between the signals, in the DCF protocol, the receiving communication node Rx senses a carrier during a fixed period and a variable period before performing transmission. The fixed period is a DFC inter frame space 220 (hereinafter, referred to as “DIFC”), and the variable period is a random backoff 230.

A transmitting communication node Tx generates a random backoff interval before transmitting in order to minimize the probability of collision with frames transmitted by other communication nodes, senses a carrier, i.e., the status of the channel for the DIFS interval. If the wireless channel is sensed idle for more than the DIFS interval, then the transmitting communication node Tx decrements a backoff counter. If the backoff counter is 0, the transmitting communication node Tx transmits data.

The transmitting communication node Tx transmits a transmission request message RTS to the receiving communication node Rx immediately after the random backoff interval is terminated, and waits for a transmission confirmation message CTS to be transmitted from the receiving communication node Rx in response to the transmission request message. Then, the receiving communication node Rx senses the carrier from other communication nodes in response to the transmission request message transmitted from the transmitting communication node Tx so as to detect whether or not the wireless channel is idle. If the wireless channel is sensed idle so that the receiving communication node Rx can receive data from other communication nodes without any interference, the receiving communication node Rx then transmits the transmission confirmation message RTS to the transmitting communication node Tx.

When the transmitting communication node Tx receives the transmission confirmation message CTS from the receiving communication node Rx, it transmits an MAC protocol data unit (MPUD) to the receiving communication node Rx after a period of time called short inter frame space (SIFS), which is shorter than the DIFS. Then, when the receiving communication node Rx completes reception of the last bit of the MAC protocol data unit (MPUD), it transmits a confirmation message ACK to the transmitting communication node Tx after the lapse of an SIFS to inform the transmitting communication node Tx that the reception of the MAC protocol data unit (MPUD) has been completed.

FIG. 3 is flowchart illustrating another example of a method of controlling access to a wireless channel for transmitting and receiving data in accordance with a conventional distributed coordination function (DCF) protocol. A method for transmitting and receiving data described in FIG. 3 is the same as that shown in FIG. 2 except that the kind of data transmitted in FIG. 3 are different from that in FIG. 2.

The transmitting communication node Tx senses a carrier for both the DIFS interval and the random backoff interval. If it is sensed that the wireless channel is idle, the transmitting communication node Tx transmits a transmission request message RTS to the receiving communication node Rx immediately after the random backoff interval is terminated, and then the receiving communication node Rx transmits a transmission confirmation message CTS to the transmitting communication node Tx in response to the transmission request message.

Then, the transmitting communication node Tx aggregates a plurality of MAC Protocol Data Units (MPDUs) into an aggregated-MAC Protocol Data Units (A-MPUD) to generate a single integrated frame, and transmits the generated integrated frame to the receiving communication node Rx through the wireless channel. Then, the receiving communication node Rx receives the integrated frame from the transmitting communication node Tx and fragments the received integrated frame into the respective MAC Protocol Data Units (MPDUs).

### DISCLOSURE OF INVENTION

### Technical Problem

The above-mentioned conventional method of controlling a wireless channel access according to a distributed coordination function (DCF) protocol activates only main communication between a transmitting communication node and a receiving communication node, and restricts any access of peripheral communication nodes of the transmitting communication node and the receiving communication node to the wireless channel during the main communication so that data can be transmitted and received safely while preventing collision between signals. That is, such a conventional method of controlling a wireless channel access according to a distributed coordination function (DCF) protocol always determines the interference range based on a predetermined carrier sense threshold (CST), and determines all the peripheral communication nodes which are in the determined interference range to be interference nodes.

However, unlike the interference range determined based on the carrier sense, an actual interference range interrupting main communication between communication nodes being activated is determined by the distance between the transmitting and receiving communication nodes being activated, i.e., the signal strength of the transmitting communication node and the receiving communication node, and the number of the peripheral communication nodes. Thus, the conventional wireless channel access control method entails a problem in that since the peripheral communication nodes which is in the interference range is actually remote from the activated communication nodes, although they do not interrupt the main communication between the activated communication nodes, the access of the peripheral communication nodes to the wireless channel is restricted and a wireless channel resource is not efficiently utilized.

Accordingly, the present invention has been made to solve the above-mentioned problems associated with the prior art, and it is an object of the present invention to provide a method of controlling wireless channel access, in which it is determined whether or not peripheral communication nodes attempting to perform main communication actually interrupt the main communication, and if it is determined that the peripheral communication nodes are ones which does not interrupt the main communication, they gain access to a wireless channel so as to perform parallel communication with respect to the main communication.

### Technical Solution

To accomplish the above object, according to one exemplary embodiment of the present invention, there is provided a method of controlling access of communication nodes to a wireless channel so as to allow the communication nodes to access the wireless channel to transmit and receive data therebetween, the method including the steps of: (a) calculating the values of parallel communication determining factors for determining whether or not peripheral communication nodes of a transmitting communication node or a receiving communication node which is activated can perform parallel communication with respect to the main communication between the transmitting communication node and the receiving communication node without interrupting the main communication between the transmitting communication node and the receiving communication node; (b) generating a parallel communication determining frame including the calculated values of the parallel communication determining factors; and (c) broadcasting, an integrated frame in which the generated parallel communication determining frame and a data frame are combined with each other, to the peripheral communication nodes.

To accomplish the above object, according to another exemplary embodiment of the present invention, there is provided a method of controlling access of communication nodes to a wireless channel so as to allow the communication nodes to access the wireless channel to transmit and receive data therebetween, the method including the steps of: receiving, a parallel communication determining frame used to determine whether or not peripheral interference nodes of the transmitting communication node and the receiving communication node can perform parallel communication with respect to the main communication between the transmitting communication node and the receiving communication node without interrupting the main communication between the transmitting communication node and the receiving communication node, from the transmitting communication node which accesses the wireless channel and transmits the data to the receiving communication node; extracting, the values of parallel communication determining factors for determining whether or not the peripheral interference nodes can perform the parallel communication, from the received parallel communication determining frame; determining whether or not the peripheral interference nodes can access the wireless channel so as to perform parallel communication with respect to the main communication between the transmitting communication node and the receiving communication node without interrupting the main communication based on the extracted parallel communication determining factors; and controlling the access of the peripheral interference nodes to the wireless channel based on a result of the determination step.

To accomplish the above object, according to another exemplary embodiment of the present invention, there is provided an apparatus for controlling access to a wireless channel, including: a parallel communication determining factor extracting unit for receiving, a parallel communication determining frame used to determine whether or not peripheral interference nodes of a transmitting communication node and a receiving communication node can perform parallel communication with respect to the main communication between the transmitting communication node and the receiving communication node without interrupting the main communication between the transmitting communication node and the receiving communication node, from the transmitting communication node which accesses the wireless channel and transmits/receives the data to/from the receiving communication node, and extracting parallel communication determining factors from the received a parallel communication determining frame; a determining unit for determining whether or not the peripheral interference nodes can perform the parallel communication with respect to the main communication based on the extracted parallel communication determining factors; and a wireless channel access control unit for controlling the interference nodes to access the wireless channel so as to perform parallel communication with respect to the main communication for a remaining communication time allocated to main communication if it is determined that the peripheral interference nodes can perform the parallel communication with respect to the main communication.

### Advantageous Effects

According to the wireless channel access control method of the present invention has a variety of following advantageous effects over the conventional wireless channel access control method.

First, it is determined whether or not peripheral communication nodes actually interrupt main communication, and if it is determined that the peripheral communication nodes are ones which does not interrupt the main communication, they gain access to a wireless channel so as to perform parallel communication with respect to the main communication, thereby efficiently utilizing a limited wireless channel resource.

Second, a parallel communication determining frame is integrated with an A-MPDU, and the control of the wireless channel for the main communication is performed according to the conventional DCF protocol so that the inventive wireless channel access control method can be used while maintaining easy compatibility with the IEEE 802.11 standard.

### BRIEF DESCRIPTION OF DRAWINGS

FIG. 1 is a diagram illustrating one example of a wireless LAN (WLAN) network including eight communication nodes.

FIG. 2 is a flowchart illustrating one example of a method of controlling access to a wireless channel for transmitting and receiving data in accordance with a conventional distributed coordination function (DCF) protocol.

FIG. 3 is flowchart illustrating another example of a method of controlling access to a wireless channel for transmitting and receiving data in accordance with a conventional distributed coordination function (DCF) protocol.

FIG. 4 is a diagrammatic view illustrating a first interference model in which one interference node and activated communication nodes exist.

FIG. 5 is a diagrammatic view illustrating a second interference model in which a plurality of interference nodes I₁, I₂, . . . , Iₙ exists around an activated receiving communication node R and a transmitting communication node T.

FIG. 6 illustrates a main communication range, a parallel communication range and a parallel communication disabling range, which are used in the present invention;

FIG. 7 illustrates the relationship among the number (n) of interference nodes positioned beyond the main communication range, the distance (SRD) between the transmitting communication node and the receiving communication node, and the parallel communication range (green zone).

FIG. 8 illustrates one example of an area of the main communication range and the number (n) of interference nodes according to the area of main communication range.

FIG. 9 is a flowchart illustrating a process in which a transmitting communication node transmits a parallel communication determining frame to peripheral communication nodes so as to control access to a wireless channel according to one embodiment of the present invention.

FIG. 10 is a view illustrating one example of an integrated frame generated from a transmitting communication node according to the present invention.

FIG. 11 is a flowchart illustrating a process in which an interference node controls access to an wireless channel based on the parallel communication determining frame according to one embodiment of the present invention.

FIG. 12 is a functional block diagram illustrating an apparatus for controlling access to a wireless channel according to one embodiment of the present invention.

FIG. 13 is a functional block diagram illustrating a parallel communication determining unit according to the present invention.

FIG. 14 is a view illustrating a variety of examples which control the access of the interference nodes positioned in the parallel communication range and the parallel communication disabling range to the wireless channel depending on a result of the determination of whether or not the parallel communication is enabled.

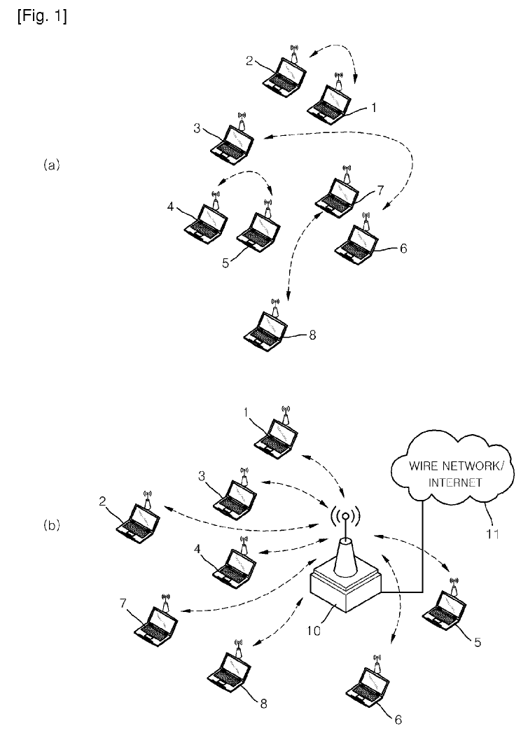

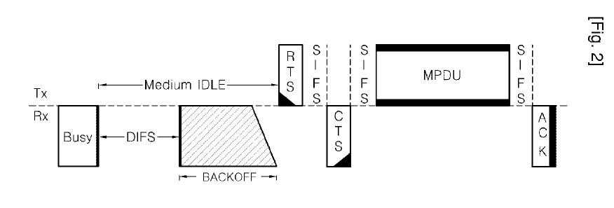

### BEST MODE FOR CARRYING OUT THE INVENTION

Now, the method and apparatus for controlling access to a wireless channel according to a preferred embodiment of the present invention will be described hereinafter in more detail with reference to the accompanying drawings.

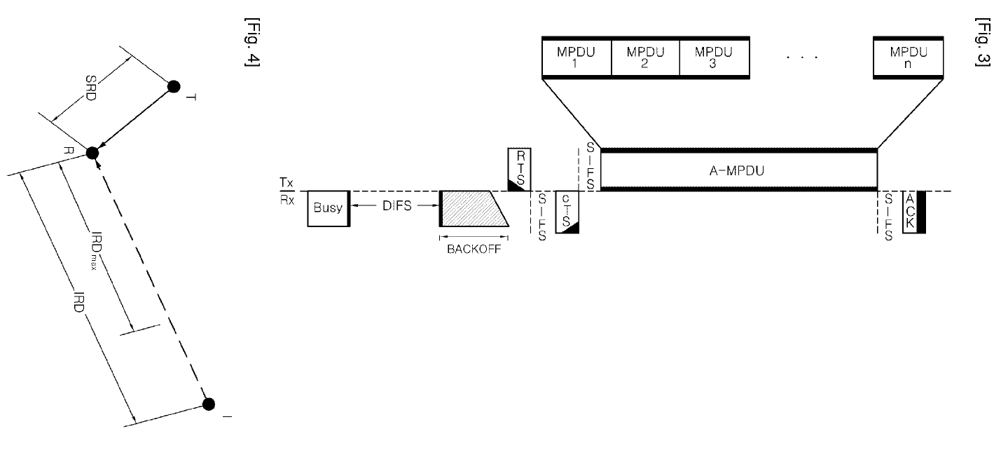

FIG. 4 is a diagrammatic view illustrating a first interference model in which one interference node and activated communication nodes exist.

The first interference model will be described hereinafter with reference to FIG. 4.

Referring to FIG. 4, an activated transmitting communication node T and an interference node I are positioned in the receiving range of an activated receiving communication node R. The distance between the activated transmitting communication node T and the activated receiving communication node R is represented by SRD, and the distance between the interference node I and the activated receiving communication node R is represented by IRD.

The activated receiving communication node R receives signals from the activated transmitting communication node T and the interference node I, respectively. According to the distributed coordination function (DCF) protocol, the activated receiving communication node R strictly limits the access of the interference node Ito the wireless channel through carrier sense in order to prevent interference generated by the signals transmitted from the activated transmitting communication node T and the interference node I. However, the determination whether the interference node actually interrupts the communication of the activated receiving communication node R is performed by a difference in the relative strength of a signal between the activated transmitting communication node R and the interference node I, which is received by the activated receiving communication node R, i.e., the distance between the transmitting communication node T and the interference node I which are remote from the receiving communication node R, but not by whether or not the interference node is a transmitting node whose carrier is sensed by the receiving communication node R, i.e., whether or not the interference node is in the interference range of the receiving communication node.

The strength of the signal received from the activated receiving communication node R and the interference node I is calculated by the following Equation 1:

[Equation 1]

$$r ( d ) = r ( d \text{-} ref ) - γ {log}_{10} \frac{d}{d \text{-} ref}$$

where r(d) denotes the strength of the received signal which is remote by a distance d, d-ref denotes a reference distance (preferably, 1m) from the transmitting communication node, and γ denotes a path loss coefficient (2≦γ≦6).

Thus, whether the interference node actually interrupts the communication of the activated receiving communication node R is determined depending on a threshold value CPT of the signal strength or a signal-to-noise ratio (SINR), in which the receiving communication node R can extract the signal of the transmitting communication node T in spite of an interference signal transmitted from the interference node I. The distance in which the receiving communication node R receives a signal from the transmitting communication node T in spite of the interference signal of the interference node I is calculated by the following Equation 2:

IRD≧SRD×βₒ^{γ} [Equation 2]

where

βₒ^{γ}

denotes the minimum signal-to-noise ratio (SIRD) or the threshold value (CPT) of the signal strength in which the receiving communication node R can extract a signal from the transmitting communication node T in spite of the interference signal of the interference node I.

IRDₘₐₓ denotes the maximum distance in which the receiving communication node R cannot extract the signal of the transmitting communication node T due to the interference signal of the interference node I. The activated receiving communication node R can accurately receive the signal of the activated transmitting communication node T when the position of the interference node I satisfies the relationship of IRD≧IRDₘₐₓ.

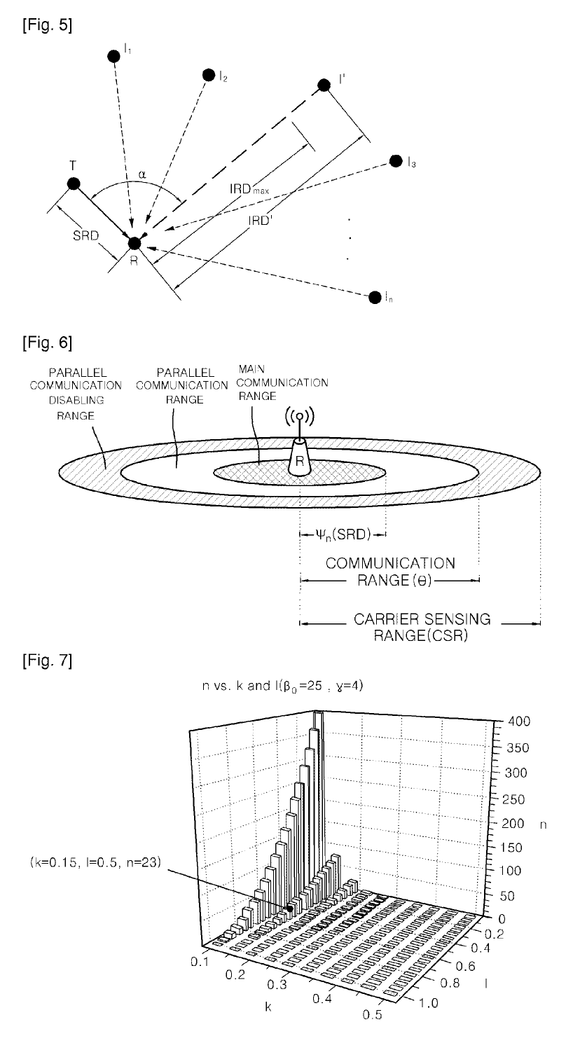

FIG. 5 is a diagrammatic view illustrating a second interference model in which a plurality of interference nodes I₁, I₂, I₃, . . . , Iₙ exists around an activated communication node R and a transmitting communication node T.

Referring to FIG. 5, the plurality of interference nodes I₁, I₂, I₃, . . . , Iₙ positioned around an activated communication node R and a transmitting communication node T can be defined as a virtual interference node I′ by the following Equation 3.

$$I R {D}^{′} = \frac{1}{γ} \sqrt{\frac{1}{{\sum }_{j = 1}^{n} {d}_{j}}} \times Π {d}_{j} \qquad [ Equation 3 ]$$

where IRD′ denotes the distance between the virtual interference node I′ and the activated receiving communication node R, and dⱼ denotes the distance between the plurality of interference nodes I_{I}, I₂, I₃, . . . , Iₙ and the receiving communication node R.

FIG. 6 illustrates a main communication range, a parallel communication range and a parallel communication disabling range, which are used in the present invention.

Referring to FIG. 6, a main communication range (forbidden zone), a parallel communication range (green zone) and a parallel communication disabling range (yellow zone) are disposed at the periphery of the activated receiving communication node R. The main communication range, the parallel communication range and the parallel communication disabling range are distinguished from one another by a communication accommodating distance (Φₙ(SRD)) of n-interference nodes, a communication distance (Θ) between the receiving communication node and the transmitting communication node, and a carrier sense distance (CSR), centering on the activated receiving communication node R.

The communication accommodating distance (Φₙ(SRD)) of the n-interference nodes is defined by the following Equation 4:

Φₙ(SRD)=SRD×{(n+1)βₒ}^{1/γ} [Equation 4]

where SRD denotes a distance between the receiving communication node and the transmitting communication node,

βₒ

denotes a threshold value (CPT) of the signal strength, in which the receiving communication node R can extract the signal of the transmitting communication node T required by the receiving communication node, n denotes the number of interference nodes which do not interrupt the main communication between the receiving communication node and the transmitting communication node while being positioned beyond the main communication range.

The communication distance (Θ) means the maximum distance in which the receiving communication node and the transmitting communication node can communicate with each other, and the carrier sense distance (CSR) means a distance determined by the carrier sense threshold (CST) and is used as the same meaning as the interference range.

In the main communication range determined by the communication accommodating distance (Φₙ (SRD)) of the n-interference nodes, the receiving communication node and the transmitting communication node can perform the main communication therebetween without being influenced by any interference of the n-interference nodes which are positioned beyond the main communication range. A maximum of n-interference nodes positioned in the parallel communication range (green zone) between the communication accommodating distance (Φₙ(SRD)) of the n-interference nodes and the communication distance (Φ) do not interrupt the main communication, and can access the wireless channel so as to perform the parallel communication relative to the main communication. The interference nodes positioned in the parallel communication disabling range (yellow zone) between the communication distance (Φ) and the carrier sense distance (CSR) cannot perform the parallel communication relative to the main communication.

Thus, the conventional wireless channel access control method according to the DCF protocol restricts the access of all the nodes positioned in the carrier sense distance to the wireless channel by determining the nodes to be temporary interference nodes, but the wireless channel access control method according to the present invention allows the interference nodes positioned in the parallel communication range within the carrier sense distance to access the wireless channel so as to perform the parallel communication with respect to the main communication between the transmitting communication node and the receiving communication node when the interference nodes are so remote from the transmitting communication node and the receiving communication node that they do not interrupt the main communication.

FIG. 7 illustrates the relationship among the number (n) of interference nodes positioned beyond the main communication range, the distance (SRD) between the transmitting communication node and the receiving communication node, and the parallel communication range (green zone).

In FIG. 7, k, l and n is calculated by the following Equations 5 to 7:

$$\begin{matrix}k = \frac{S R D}{Θ} , & [ Equation 5 ] \\ i = \frac{π ( {Θ}^{2} - {( {Φ}_{n} ( S R D ) )}^{2} )}{{πΦ}^{2}} , and & [ Equation 6 ] \\ n = ⌊ \frac{1}{{{β}_{0} ( \frac{\sqrt{1 - l}}{k} )}^{γ}} ⌋ & [ Equation 7 ]\end{matrix}$$

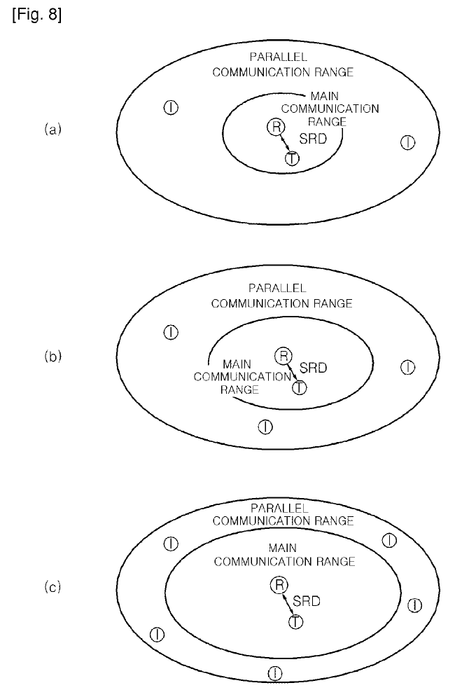

FIGS. 8(a) to 8(c) illustrate one example of an area of the main communication range and the number (n) of interference nodes according to the area of main communication range.

Referring to FIGS. 8(a) to 8(c), in the case where the number (n) of the interference nodes is fixed, when SRD is increased, the parallel communication range is decreased. In the case where SRD is fixed, when the number (n) of the interference nodes is increased, the parallel communication range is decreased, and when the parallel communication range is increased, the number (n) of the interference nodes is decreased.

Therefore, in the case where the parallel communication range (green zone) is too small, a small quantity of interference nodes are positioned in the parallel communication range so that only limited interference nodes have the opportunity of performing the parallel communication. In the meantime, in the case where the parallel communication range (green zone) is too large, a large quantity of interference nodes perform the parallel communication, resulting in an increase in the probability of interrupting the main communication. As shown in FIG. 7, most preferably, the number (n) of communication nodes which can perform parallel communication with respect to the main communication is 23 if k=0.15 and 1=0.5.

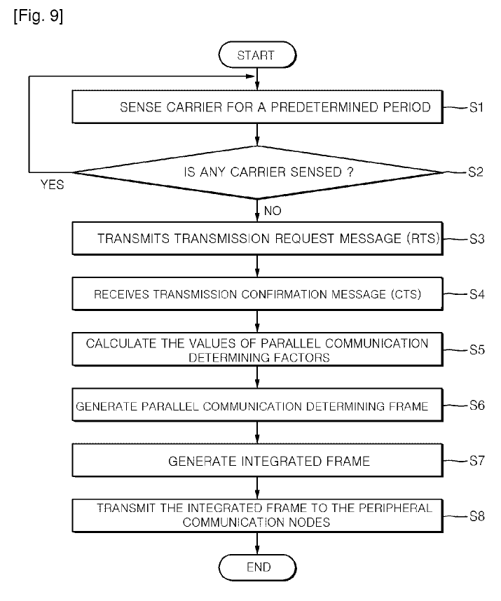

FIG. 9 is a flowchart illustrating a process in which a transmitting communication node transmits a parallel communication determining frame to peripheral communication nodes so as to control access to a wireless channel according to one embodiment of the present invention.

Referring to FIG. 9, the transmitting communication node senses a carrier for both a fixed period (DIFS) and a variable period (Backoff) before transmitting data to the receiving communication node according to the DCF protocol (S1). It is determined whether or not the transmitting communication node senses a carrier for both the fixed period (DIFS) and the variable period (Backoff)(S2). If it is determined that the transmitting communication node doe not sense any carrier, the transmitting communication node transmits a transmission request message (RTS) to the receiving communication node (S3), and then receives a transmission confirmation message (CTS) from the receiving communication node responding to the transmission request message (RTS) (S4). The receiving communication node senses a carrier transmitted from other communication nodes in response to the transmission request message (RTS) from the transmitting communication node and detects whether or not the wireless channel is idle. If the wireless channel is sensed idle so that the receiving communication node Rx can receive data from the transmitting communication node without any interference of other communication nodes, the receiving communication node then broadcasts the transmission confirmation message (RTS) to interference nodes positioned in the communication range of the transmitting communication node and the receiving communication node.

If the transmitting communication node receives the transmission confirmation message from the receiving communication node, it calculates the values of parallel communication determining factors for determining whether or not peripheral communication nodes of the transmitting communication node or the receiving communication node can perform parallel communication with respect to the main communication between the transmitting communication node and the receiving communication node without interrupting the main communication between the transmitting communication node and the receiving communication node.

The parallel communication determining factors include the strength (DPL) of the transmitted signal, the threshold value (CPT) of the signal strength in which the receiving communication node can extract a signal of the transmitting communication node in spite of an interference signal, and the distance (SRD) between the receiving communication node and the transmitting communication node. Preferably, the strength (DPL) of the transmitted signal is determined in proportional to the signal strength of the transmission confirmation message transmitted from the receiving communication node, the threshold value (CPT) of the signal strength is determined by a signal modulating and coding method in a modulating and coding scheme (MCS) table, AND the distance (SRD) between the receiving communication node and the transmitting communication node is determined by using the Equation 1 based on the signal strength of the transmission confirmation message.

The transmitting communication node generates a parallel communication determining frame (IF-Frame) including the calculated values of the parallel communication determining factors (S6), and combines the generated parallel communication determining frame with a data frame (MPDU) or a plurality of data frames (A-MPDU) to generate an integrated frame (S7). The transmitting communication node broadcasts the integrated frame combined with the parallel communication determining frame to the receiving communication node positioned in the communication range of the transmitting communication node and the interference nodes (S8).

Preferably, the receiving communication node removes the parallel communication determining frame in the received integrated frame and extracts only the data frame. Then, the interference nodes which are positioned in the communication range of the transmitting communication node and receives the integrated frame extracts only the parallel communication determining frame from the received integrated frame, and determines whether or not they can access the wireless channel so as to perform parallel communication with respect to the main communication.

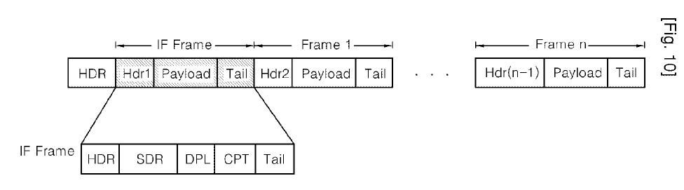

FIG. 10 is a view illustrating one example of an integrated frame generated from a transmitting communication node according to the present invention.

Referring to FIG. 10, the integrated frame includes a header, a parallel communication determining frame (IF-Frame), and a plurality of data frames (Frame1, . . . , Frame(last)). The parallel communication determining frame is integrated into the first frame position, and consists of fields having a header, an SRD, a DPL and a CPT stored therein. Depending on the area to which the present invention is applied, the integrated frame can be employed in which the parallel communication determining frame and one data frame, but not the plurality of data frames. This falls within the scope of the present invention.

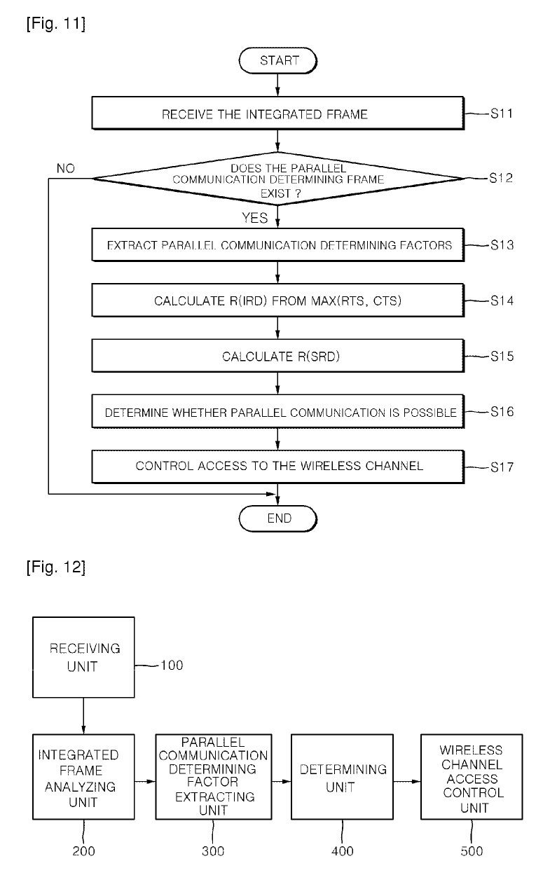

FIG. 11 is a flowchart illustrating a process in which an interference node controls access to the wireless channel based on the parallel communication determining frame according to one embodiment of the present invention.

Referring to FIG. 11, the interference nodes, which attempt to access a wireless channel while being positioned in the communication range of the transmitting communication node so as to perform parallel communication relative to the main communication between an activated transmitting communication node and an activated receiving communication node, receives the integrated frame including the parallel communication determining frame from the transmitting communication node (S11), and determines whether or not the parallel communication determining frame exists in the received integrated frame (S12). Whether or not the parallel communication determining frame exists in the received integrated frame is determined through information stored in the header of the integrated frame.

If the parallel communication determining frame exists in the received integrated frame, the interference nodes separate the parallel communication determining frame from the received integrated frame and extract the parallel communication determining factors from the separated parallel communication determining frame (S13).

Meanwhile, the interference nodes calculate the strength (r(IRD)) of a signal transmitted therefrom to the activated transmitting communication node or the activated receiving communication node based on the signal strength of the transmission request message (RTS) transmitted from the activated transmitting communication node or the signal strength of the transmission confirmation message (CTS) transmitted from the activated receiving communication node (S14). The strength (r(IRD)) of the signal, which is transmitted therefrom to the activated transmitting communication node or the activated receiving communication node interference node, is measured as follows in the activated transmitting communication node or the activated receiving communication node interference node. First, the interference nodes measure the signal strengths of the transmission request message (RTS) or the transmission confirmation message (CTS) transmitted to the interference node from the activated transmitting communication node or the activated receiving communication node, and select a communication node which is positioned nearer to the interference node from the transmitting communication node and the receiving communication node. The interference nodes calculate the distance (IRD) between the interference nodes and the selected communication node by applying the signal strength of the selected communication node to Equation 1. The strength (r(IRD)) of the signal, which is transmitted to the selected communication node from the interference nodes is measured by substituting the calculated distance (IRD) into the following Equation 8:

(r(IRD))=PLmax−γ log₁₀(IRD) [Equation 8]

where PLmax denotes the strength of the maximum transmitted signal of the interference node.

In addition, the interference nodes calculate the signal strength (r(SRD)) between the activated transmitting communication node and the activated receiving communication node by using the following Equation 9 based on the parallel communication determining factors (DPL, SRD):

r(SRD)=DPL−γ log₁₀(SRD) [Equation 9]

It is determined whether or not the interference nodes can access the wireless channel so as to perform parallel communication with respect to the main communication for the communication time (PXOP) allocated to main communication without interrupting the main communication based on r(IRD), r(SRD), the number (n) of the interference nodes positioned between the main communication range and the parallel communication range, and CPT values which have been calculated (S16). If it is determined that the interference nodes do not interrupt the main communication, the interference nodes are controlled to access the wireless channel (S17).

FIG. 12 is a functional block diagram illustrating an apparatus for controlling access to a wireless channel according to one embodiment of the present invention.

The elements constituting the apparatus for controlling access to the wireless channel according to the present invention can be implemented in a physical layer and a MAC layer according to the IEEE 802.11 standard.

Referring to FIG. 12, a receiving unit 100 receives an integrated frame including a parallel communication determining frame, and an integrated frame analyzing unit 200 analyzes and distinguishes the parallel communication determining frame and a data frame (MPDU) in the received integrated frame. Preferably, the parallel communication determining frame and the data frame can be distinguished from each other through a header of each frame.

A parallel communication determining factor extracting unit 300 extracts the parallel communication determining factors stored in a data field of the distinguished parallel communication determining frame. In the present invention, the parallel communication determining factors used to determine whether or not the interference nodes can perform parallel communication with respect to the main communication without interrupting the main communication include the strength (DPL) of the transmitted signal, the threshold value (CPT) of the signal strength in which the receiving communication node can extract a signal of the transmitting communication node in spite of an interference signal, and the distance (SRD) between the receiving communication node and the transmitting communication node.

A determining unit 400 determines whether or not the interference nodes can perform parallel communication with respect to the main communication without interrupting the main communication between the activated transmitting communication node and the activated receiving communication node. Based on a result of the determination of the determining unit 400, if a wireless channel access control unit 500 determines that the interference nodes do not interrupt the main communication, it controls the interference nodes to access the wireless channel so as to perform the parallel communication with respect to the main communication.

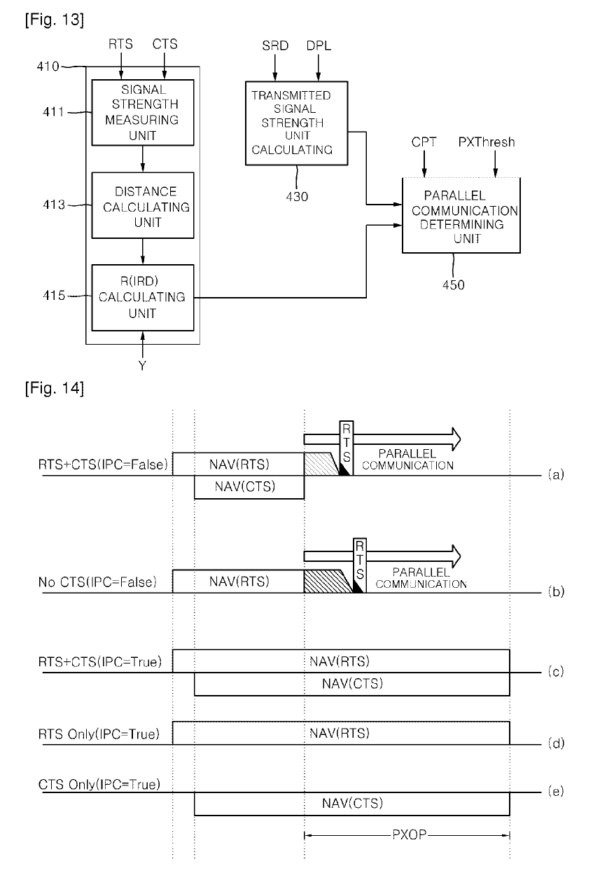

FIG. 13 is a functional block diagram illustrating a parallel communication determining unit according to the present invention.

Referring to FIG. 13, the determining unit 400 includes a received signal strength calculating unit 410 for calculating the strength (r(IRD)) of a signal which is transmitted from the interference nodes to the activated transmitting communication node or the activated receiving communication node and is measured in the activated transmitting communication node or the activated receiving communication node, a transmitted signal strength calculating unit 430 for calculating the strength of a signal transmitted from the transmitting communication node based on the extracted parallel communication determining factors, and a parallel communication determining unit 450 for determining whether or not the interference nodes can perform parallel communication with respect to the main communication without interrupting the main communication between the activated transmitting communication node and the activated receiving communication node.

The received signal strength calculating unit 410 will be described hereinafter in more detail.

The received signal strength calculating unit 410 includes a signal strength measuring unit 411 for measuring the signal strength of the transmission request message (RTS) or the signal strength of the transmission confirmation message (CTS) received from the interference nodes and selecting the message whose signal strength is larger in the signal strengths, a distance calculating unit 413 for applying the selected signal strength to Equation 1 to calculate the distance (IRD) between the interference nodes and the activated communication node transmitting the selected message, and an r(IRD) calculating unit 415 for calculating the strength (r(IRD)) of a signal which is transmitted to a communication node selected by the interference nodes and is measured in the selected communication node by using Equation 8.

In the meantime, the parallel communication determining unit 450 will be described hereinafter in more detail.

The parallel communication determining unit 450 determines whether or not the interference nodes can access the wireless channel so as to perform parallel communication with respect to the main communication without interrupting the main communication between the activated transmitting communication node and the activated receiving communication node by applying r(IRD), r(SRD), CPT and PXThresh to the following Equation 10:

$$I P C = \frac{r ( S R D )}{PXThresh \times r ( I R D )} > C P T . \qquad [ Equation 10 ]$$

where PXThresh denotes a threshold value of the parallel communication node, which means the number of interference nodes which can perform the parallel communication with respect to the main communication between the activated communication nodes in the parallel communication range without interrupting the main communication.

If the IPC value is true, the parallel communication determining unit 450 determines that the parallel communication is disabled. If the IPC value is false, the parallel communication determining unit 450 determines that the parallel communication is enabled. That is, the IPC value represents a false value only when the interference nodes are positioned in the parallel communication range.

FIG. 14 is a view illustrating a variety of examples which control the access of the interference nodes positioned in the parallel communication range and the parallel communication disabling range to the wireless channel depending on a result of the determination of whether or not the parallel communication is enabled.

In FIG. 14(a), the interference nodes positioned in parallel communication range of the transmitting communication node and the receiving communication node receive the transmission request message (RTS) from the transmitting communication node and the transmission confirmation message (CTS) from the receiving communication node. If the result of the determination is false, the interference nodes perform parallel communication with respect to the main communication after a lapse of the variable period.

In FIG. 14(b), the interference nodes positioned in parallel communication range of the transmitting communication node but positioned beyond the parallel communication range of the receiving communication node receive only the transmission request message (RTS) from the transmitting communication node. If the result of the determination is false, the interference nodes perform parallel communication with respect to the main communication after a lapse of the variable period.

In FIG. 14(c), the interference nodes positioned in parallel communication range of the transmitting communication node and the receiving communication node receive the transmission request message (RTS) from the transmitting communication node and the transmission confirmation message (CTS) from the receiving communication node, but is positioned beyond the main communication range of the activated communication node. Thus, if the result of the determination is true, the interference nodes do not access the wireless channel.

In FIG. 14(d), the interference nodes positioned in parallel communication range of the transmitting communication node but positioned beyond the parallel communication range of the receiving communication node receive the transmission request message (RTS) from the transmitting communication node, but is positioned in the parallel communication disabling range. Thus, if the result of the determination is true, the interference nodes do not access the wireless channel.

In FIG. 14(e), the interference nodes positioned in parallel communication range of the receiving communication node but positioned beyond the parallel communication range of the transmitting communication node receive only the transmission confirmation message (CTS) from the receiving communication node, but do not receive the transmission request message and the parallel communication determining frame from the transmitting communication node. If the result of the determination is true, the interference nodes do not access the wireless channel.

Meanwhile, the above-mentioned embodiments of the present invention can be implemented in a program which can be executed in a computer, and can be implemented in a general purpose digital computer executing the program using a recoding medium readable by a computer.

The recording medium readable by the computer includes a magnetic storage medium such as, for example, ROMs, floppy disks, hard disks and the like, an optical reading medium such as, for example, CD-ROMs, DVDs and the like, and a carrier wave storage medium such as, for example, transmission over the Internet.

Although the preferred embodiments of the present invention have been described in connection with the exemplary embodiments illustrated in the drawings, they are merely illustrative embodiments. It will be appreciated that and various equivalent modifications and variations of the embodiments can be made by a person having an ordinary skill in the art without departing from the spirit and scope of the present invention. Therefore, the true technical scope of the present invention should be defined by the technical spirit of the appended claims.

1. A method of controlling access of communication nodes to a wireless channel so as to allow the communication nodes to access the wireless channel to transmit and receive data therebetween, the method comprising the steps of:
(a) calculating the values of parallel communication determining factors for determining whether or not peripheral communication nodes of a transmitting communication node or a receiving communication node which is activated can perform parallel communication with respect to the main communication between the transmitting communication node and the receiving communication node without interrupting the main communication between the transmitting communication node and the receiving communication node;
(b) generating a parallel communication determining frame including the calculated values of the parallel communication determining factors; and
(c) broadcasting, an integrated frame in which the generated parallel communication determining frame and a data frame are combined with each other, to the peripheral communication nodes.

2. The method according to claim 1, wherein the step (a) comprises the steps of: transmitting a transmission request message (Request-to-Send; RTS) to the receiving communication node;
receiving from a transmission confirmation message (Clear-to-Send; CTS) from the receiving communication node in response to the transmission request message; and
calculating the values of the parallel communication determining factors based on the signal strength of the received transmission confirmation message and the distance between the peripheral communication nodes and the transmitting communication node.

3. The method according to claim 2, wherein the parallel communication determining factors comprises the distance (SRD) between the receiving communication node and the transmitting communication node, the strength (DPL) of the transmitted signal of the transmitting communication node, and the threshold value (CPT) of the signal strength in which the receiving communication node can extract a signal of the transmitting communication node.

4. The method according to claim 3, wherein the distance (SRD) between the receiving communication node and the transmitting communication node is calculated based on the strength of the transmission confirmation message, the strength (DPL) of the transmitted signal of the transmitting communication node is calculated based on a signal strength corresponding to the signal strength of transmission confirmation message, and
the threshold value (CPT) of the signal strength is calculated based on the distance between the peripheral communication nodes and the transmitting communication node.

5. The method according to claim 3, wherein the transmitting communication node is controlled such that it accesses the wireless channel in accordance with the Carrier Sense Multiple Access with Collision Avoidance (CSMA/CA) protocol according to the IEEE 801.11 standard before accessing the wireless channel so as to perform the main communication with the receiving communication node.

6. The method according to claim 3, wherein the transmitting communication node is controlled such that it accesses the wireless channel in accordance with the Carrier Sense Multiple Access with Collision Avoidance (CSMA/CA) MAC protocol according to the IEEE 801.11 standard before accessing the wireless channel so as to perform the main communication with the receiving communication node.

7. A method of controlling access of communication nodes to a wireless channel so as to allow the communication nodes to access the wireless channel to transmit and receive data therebetween, the method comprising the steps of:
(a) receiving, a parallel communication determining frame used to determine whether or not peripheral interference nodes of the transmitting communication node and the receiving communication node can perform parallel communication with respect to the main communication between the transmitting communication node and the receiving communication node without interrupting the main communication between the transmitting communication node and the receiving communication node, from the transmitting communication node which accesses the wireless channel and transmits the data to the receiving communication node;
(b) extracting, the values of parallel communication determining factors for determining whether or not the peripheral interference nodes can perform the parallel communication, from the received parallel communication determining frame;
(c) determining whether or not the peripheral interference nodes can access the wireless channel so as to perform parallel communication with respect to the main communication between the transmitting communication node and the receiving communication node without interrupting the main communication based on the extracted parallel communication determining factors; and
(d) controlling the access of the peripheral interference nodes to the wireless channel based on a result of the determination in the step (c).

8. The method according to claim 7, wherein the parallel communication determining frame is received with it combined with one data frame or a plurality of data frame, and the parallel communication determining factors is extracted from the parallel communication determining frame separated from the received data frame.

9. The method according to claim 7, wherein the parallel communication determining factors included in the parallel communication determining frame comprises the distance between the receiving communication node and the transmitting communication node, the strength of the transmitted signal of the transmitting communication node, and the threshold value of the signal strength in which the receiving communication node can extract a signal of the transmitting communication node.

10. The method according to claim 7, wherein the step (c) further comprises the steps of:
(c1) selecting a signal which is received with a higher strength (r(IRD)) of the signals received from the transmitting communication node and the receiving communication node;
(c2) calculating the strength (r(SRD)) of the transmitted signal of the transmitting communication node using the extracted parallel communication determining factors; and
(c3) determining whether or not the peripheral communication nodes can access the wireless channel so as to perform parallel communication with respect to the main communication between the transmitting communication node and the receiving communication node without interrupting the main communication, based on the strength (r(IRD)) of the selected received signal, the calculated strength (r(SRD)) of the transmitted signal, the number (PTXhresh) of the peripheral communication nodes which can perform parallel communication with respect to the main communication without interrupting the main communication, and the threshold value (CPT) of the signal strength in which the receiving communication node can extract a signal of the transmitting communication node.

11. The method according to claim 10, wherein whether or not the peripheral communication nodes can access the wireless channel so as to perform parallel communication in the step (c3) is determined by the following Equation 1:
$$I P C = \frac{r ( S R D )}{PXThresh \times r ( I R D )} > C P T \qquad [ Equation 1 ]$$
In the step (d), if the Equation 1 is not satisfied, the peripheral communication nodes is controlled so as not to access the wireless channel to perform parallel communication with respect to the main communication, and
if the Equation 1 is satisfied, the peripheral communication nodes is controlled so as to access the wireless channel to perform parallel communication with respect to the main communication.

12. The method according to claim 11, wherein the number of the peripheral communication nodes which can perform parallel communication with respect to the main communication without interrupting the main communication is 23 if k=0.15 and 1=0.5,
wherein
$$k = \frac{S R D}{Θ}$$
$$and$$
$$i = \frac{π ( {Θ}^{2} - {( {Φ}_{n} ( S R D ) )}^{2} )}{{πΦ}^{2}} ,$$
where SRD denotes the distance between the transmitting communication node and the receiving communication node, denotes the communication distance of the transmitting communication node or the receiving communication node, and
Φₙ(SRD)=SRD×{(PXThresh+1)β₀}^{1/γ}.

13. The method according to claim 8, wherein if only data frame which does not include the parallel communication determining frame is received, the transmitting communication node is controlled such that it accesses the wireless channel in accordance with the Carrier Sense Multiple Access with Collision Avoidance (CSMA/CA) MAC protocol according to the IEEE 801.11 standard before accessing the wireless channel so as to perform the main communication with the receiving communication node.

14. An apparatus for controlling access to a wireless channel, comprising:
a parallel communication determining factor extracting unit for receiving, a parallel communication determining frame used to determine whether or not peripheral interference nodes of a transmitting communication node and a receiving communication node can perform parallel communication with respect to the main communication between the transmitting communication node and the receiving communication node without interrupting the main communication between the transmitting communication node and the receiving communication node, from the transmitting communication node which accesses the wireless channel and transmits/receives the data to/from the receiving communication node, and extracting parallel communication determining factors from the received a parallel communication determining frame;
a determining unit for determining whether or not the peripheral interference nodes can perform the parallel communication with respect to the main communication based on the extracted parallel communication determining factors; and
a wireless channel access control unit for controlling the interference nodes to access the wireless channel so as to perform parallel communication with respect to the main communication for a remaining communication time allocated to main communication if it is determined that the peripheral interference nodes can perform the parallel communication with respect to the main communication.

15. The apparatus according to claim 14, wherein the parallel communication determining unit further comprises:
a received signal strength calculating unit for calculating the strength (r(IRD)) of a signal which is transmitted with a higher strength from the peripheral interference nodes to the transmitting communication node or the receiving communication node;
a transmitted signal strength calculating unit for calculating the strength (r(SRD)) of a signal transmitted from the transmitting communication node based on the extracted parallel communication determining factors; and
a parallel communication determining unit for determining whether or not the peripheral communication nodes can access the wireless channel so as to perform parallel communication with respect to the main communication between the transmitting communication node and the receiving communication node without interrupting the main communication, based on the strength (r(IRD)) of the selected received signal, the calculated strength (r(SRD)) of the transmitted signal, the number (PTXhresh) of the peripheral communication nodes which can perform parallel communication with respect to the main communication without interrupting the main communication, and the threshold value (CPT) of the signal strength in which the receiving communication node can extract a signal of the transmitting communication node.

16. The apparatus according to claim 15, wherein the parallel communication determining unit determines whether or not to perform the parallel communication by the following Equation 2:
[Equation 2]
$$I P C = \frac{r ( S R D )}{PXThresh \times r ( I R D )} > C P T ,$$
wherein the wireless channel access control unit controls the peripheral communication nodes not to access the wireless channel to perform parallel communication with respect to the main communication if the Equation 2 is not satisfied, and
the wireless channel access control unit controls the peripheral communication nodes to access the wireless channel to perform parallel communication with respect to the main communication if the Equation 2 is satisfied.
